(19) United States
(12) Patent Application Publication
(10) Pub. No.: US 2021/0053537 A1
(43) Pub. Date: Feb. 25, 2021

(54) PROGRESSIVE STEERING SYSTEM FOR AN ALL-TERRAIN VEHICLE

(71) Applicant: Ontario Drive & Gear Limited, New Hamburg (CA)

(72) Inventors: Doug Braswell, New Hamburg (CA); Keith Heibein, New Hamburg (CA); Clay Hendricks, New Hamburg (CA); Andrew Doubet, New Hamburg (CA); Jeremy Bauman, New Hamburg (CA)

(73) Assignee: Ontario Drive & Gear Limited, New Hamburg (CA)

(21) Appl. No.: 16/997,563

(22) Filed: Aug. 19, 2020

Related U.S. Application Data
(60) Provisional application No. 62/889,034, filed on Aug. 19, 2019.

(51) Int. Cl. B60T 7/10; B60T 13/58

(52) U.S. Cl. CPC B60T 7/10; B60T 2260/02; B60T 13/588

(57) ABSTRACT

A progressive brake steering system that includes a steering shaft, a steering arm attached to the steering shaft and a spring mechanism that couples the steering arm to a first actuation pushrod of a first brake master cylinder and a second actuation pushrod of a second brake master cylinder. Rotating the steering shaft in a first direction rotates a first side of the steering shaft towards a first spring of the spring mechanism to compress the first spring against the first actuation pushrod of the first brake master cylinder to generate a first brake fluid pressure. Rotating the steering shaft in a second direction rotates a second side of the steering shaft towards a second spring of the spring mechanism to compress the second spring against the second actuation pushrod of the second brake master cylinder to generate a second brake fluid pressure.

### CROSS-REFERENCE TO RELATED APPLICATIONS

This Utility Patent Application claims priority to U.S. Ser. No. 62/889,034, filed Aug. 19, 2019, which is incorporated herein by reference.

### FIELD OF TECHNOLOGY

The present application relates to a steering system. More specifically, the present disclosure relates to a steering system for an All-Terrain Vehicle (ATV).

### BACKGROUND

Conventional 4 wheel All-Terrain Vehicles (ATVs) utilize known steering systems that result in very non-responsive steering of the ATV. Some ATVs utilize pumps and hydraulic motors to provide power and braking to the wheels of the ATV. In operation, this may provide an ATV with a zero-radius turn ability in order to maneuver in and around extreme terrain.

Conventional ATV steering is not useful for ATVs having more than four wheels. Conventional skid steering technology, when utilized in ATVs having more than four wheels, often times results in a short, jerky steering pattern. These jerky steering patterns are especially present when attempting to steer the ATV to turn within a tight turning radius.

For these and other reasons, there is a need for the present invention.

### SUMMARY

According to an embodiment of a progressive brake steering system for a vehicle, the brake steering system includes a steering shaft configured to rotate by a steering torque input from a steering device, a steering arm that is attached to the steering shaft and configured to rotate with the steering shaft, and a spring mechanism coupling the steering arm to a first actuation pushrod of a first brake master cylinder and a second actuation pushrod of a second brake master cylinder. The axis of the steering shaft is medially offset from the first actuation pushrod and the second actuation pushrod. Rotating the steering shaft in a first direction applies a steering force that rotates a first side of the steering arm towards a first end of a first spring of the spring mechanism to compress the first spring against the first actuation pushrod of the first brake master cylinder to move the first actuation pushrod to generate a first brake fluid pressure. Rotating the steering shaft in a second direction applies a steering force that rotates a second side of the steering arm towards a first end of a second spring of the spring mechanism to compress the second spring against the second actuation pushrod of the second brake master cylinder to move the second actuation pushrod to generate a second brake fluid pressure.

According to an embodiment of an All-Terrain Vehicle (ATV) with a progressive brake steering system, the ATV includes a steering shaft that includes a handlebar attached at a top end and a steering arm attached at a bottom end. The steering arm includes a first side and a second side, and the steering shaft and the steering arm are configured to rotate by a steering torque input from the handlebar. The ATV includes a first brake master cylinder and a second brake master cylinder, and a spring mechanism that includes a first spring and a second spring. The first spring couples the first side of the steering arm to a first actuation pushrod of the first brake master cylinder, and the second spring couples the second side of the steering arm to a second actuation pushrod of the second brake master cylinder. An axis of the steering shaft is medially offset from the first actuation pushrod and the second actuation pushrod. The ATV includes a right disc brake on a right side of the ATV that is in fluid communication with the first brake master cylinder. The ATV includes a left side disc brake on a left side of the ATV that is in fluid communication with the second brake master cylinder. The ATV includes three or more wheels on the right side of the ATV and three or more wheels on the left side of the ATV. The ATV includes a transmission that includes a right side drive shaft mechanically coupled to the right side disk brake and to the three or more wheels on the right side of the ATV, and a left side drive shaft mechanically coupled to the left side disk brake and to the three or more wheels on the left side of the ATV.

According to an embodiment of a dual-rate steering system for an All-Terrain Vehicle (ATV), the dual-rate steering system includes a steering shaft that includes a handlebar attached at a top end and a steering arm attached at a bottom end. The steering arm includes a first side and a second side, and the steering shaft and the steering arm are configured to rotate by a steering torque input from the handlebar. The dual-rate steering system includes a first steering system comprising a first brake master cylinder that includes a first spring and a second brake master cylinder that includes a second spring. The first spring couples the first side of the steering arm to a first actuation pushrod of the first brake master cylinder. The second spring couples the second side of the steering arm to a second actuation pushrod of the second brake master cylinder. A second steering system comprises a transmission that includes a right side drive shaft and a left side drive shaft. The right side drive shaft is coupled to a right side disk brake that is in fluid communication with the first brake master cylinder, and the left side drive shaft is coupled to a left side disk brake that is in fluid communication with the second brake master cylinder. The first steering system provides a first turning rate when rotating the steering shaft by an amount of rotation in a first direction or a second direction by compressing the first spring to move the first actuation pushrod into the first brake master cylinder to increase a first brake fluid pressure to apply a braking force to the right disk brake, or by compressing the second spring to move the second actuation pushrod into the second brake master cylinder to increase the second brake fluid pressure to apply a braking force to the left side disk brake. The second steering system provides the second turning rate when the braking force is applied to the right side disc brake by causing the transmission to increase a rotational speed of the left side drive shaft of transmission as a ratio of a reduction in rotational speed of the right side drive shaft. The second steering system provides the second turning rate when the braking force is applied to the left side disc brake by causing the transmission to increase a rotational speed of the right side drive shaft of the transmission as a ratio of a reduction in rotational speed of the left side drive shaft.

Those skilled in the art will recognize additional features and advantages upon reading the following detailed description, and upon viewing the accompanying drawings.

### BRIEF DESCRIPTION OF THE DRAWINGS

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 illustrates an embodiment of an All-Terrain Vehicle (ATV) with a progressive steering system.

FIG. 2 illustrates an embodiment of a perspective view of a progressive steering system.

FIG. 3 illustrates an embodiment of a top view of a steering system located between the handlebars and the brake system.

FIG. 4 illustrates an embodiment of a perspective view of a steering system located between the handlebars and the brake system.

FIG. 5 illustrates an embodiment of a perspective view of a steering system located between the handlebars and the brake system.

FIG. 6 illustrates an embodiment of a perspective view of a steering system located between the handlebars and the brake system.

FIG. 7 illustrates an embodiment of a transmission used as part of a braking system having a progressive steering system.

FIG. 8 illustrates an embodiment of a triple differential transmission used as part of a braking system having a progressive steering system.

FIG. 9 illustrates an embodiment of a perspective view of a progressive steering system for an ATV.

FIG. 10 illustrates an embodiment of a perspective view of a progressive steering system for an ATV that illustrates a counter-clockwise turn of the steering handle.

FIG. 11 illustrates an embodiment of a method of operating an ATV with a progressive steering system.

FIG. 12 illustrates an embodiment of a schematic illustrating a smooth driving radius of an ATV having a progressive steering system.

FIG. 13 illustrates an embodiment of a diagram illustrating a dual-rate progressive steering system for an ATV.

FIG. 14 illustrates an embodiment of a dual-rate spring for a progressive steering system for an ATV.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing”, “upper,” “lower,” “right”, “left”, “vertical,” “horizontal” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

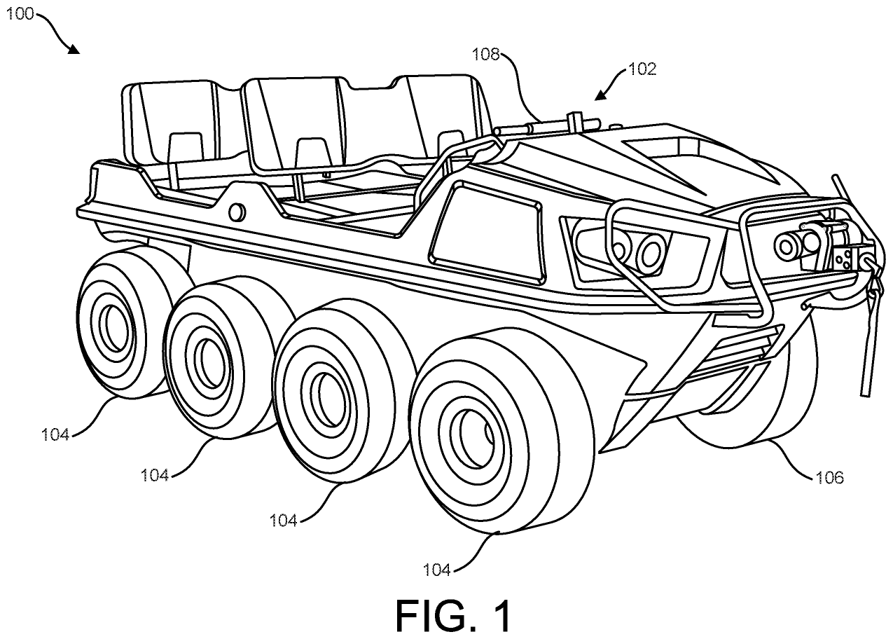

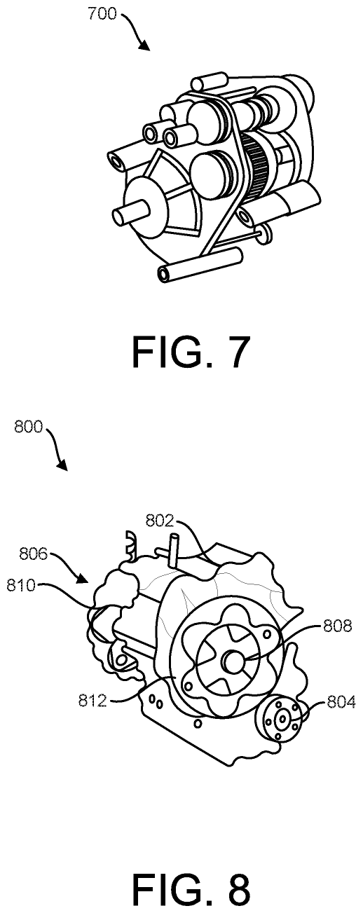

FIG. 1 illustrates an embodiment at of an All-Terrain Vehicle (ATV) at 100 with a progressive steering system. In the illustrated embodiments, a progressive steering system 102 works with a transmission such as transmission 700 or transmission 800, and with a braking system to provide a dual-rate steering system (See also, FIGS. 7 and 8). The progressive brake steering system provides a smooth turning radius for an ATV having 4 or more wheels, or having three or more wheels 104 on the right side of ATV 104, and three or more wheels 106 on the left side of ATV 100. In the illustrated embodiment, ATV 100 includes four wheels 104 on the right side of ATV 100, and includes four wheels 106 on the left side of ATV 100. ATV 100 includes a steering handlebar 108. An ATV with a progressive steering system can be used in very extreme environments.

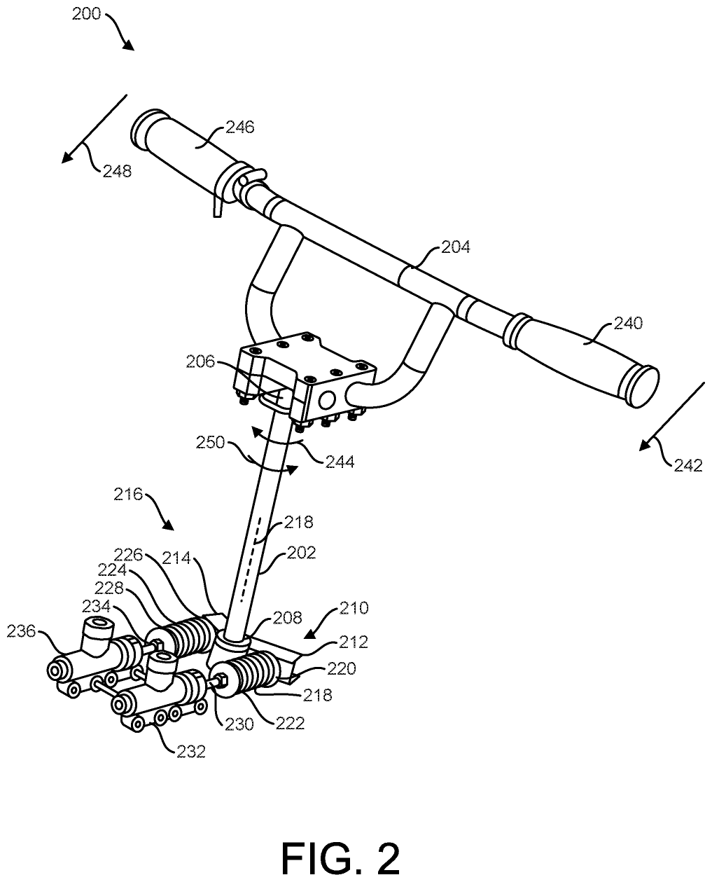

FIG. 2 illustrates an embodiment of a perspective view of a progressive steering system at 200. Progressive steering system 200 includes a steering shaft 202 that is configured to rotate by a steering torque input from a steering device. The steering torque input may be provided by a driver of a vehicle such as ATV 100. The steering device illustrated in FIG. 2 is a handlebar 204. In other embodiments, the steering device can be another suitable steering device such as a steering wheel. In the illustrated embodiment, handlebar 204 is attached at a top end 206 of the steering shaft 202, and a steering arm 210 is attached at a bottom end 208 of the steering shaft 202. Steering arm 210 rotates with the steering shaft 202 and includes a first side 212 and a second side 214. Spring mechanism 216 includes a first spring 218 having a first end 220 and a second end 222. Spring mechanism 216 includes a second spring 224 having a first end 226 and a second end 228. Spring mechanism 216 couples the steering arm 210 via first spring 218 to a first actuation pushrod 230 of a first brake master cylinder 232. Spring mechanism 216 further couples the steering arm 210 via second spring 224 to a second actuation pushrod 234 of a second brake master cylinder 236. An axis 218 of rotation of steering shaft 202 is medially offset from the first actuation pushrod 230 and the second actuation pushrod 234.

Rotating the handlebar 204 by applying a steering force at a left grip or a first side grip 240 rotates handlebar 204 in a direction 242 which causes steering shaft 202 to rotate along axis 218 in a first direction 244 which is a clockwise direction. Rotating the handlebar 204 by applying the steering force at a right grip or a second side grip 246 rotates handlebar 204 in a direction 248 which causes steering shaft 202 to rotate along axis 218 in a second direction 250 which is a counter-clockwise direction.

Rotating steering shaft 202 in the first direction 244 applies a steering force that rotates a first side 212 of the steering arm 210 towards a first end 220 of first spring 218 to compress the first spring 218 against the first actuation pushrod 230 of the first brake master cylinder 232 to move the first actuation pushrod 230 to generate a first brake fluid pressure. If the steering shaft 202 is rotated by a certain amount of rotation in the first direction 244, first spring 218 is linearly compressed by a first distance that is proportional to the amount of rotation. This increases the force that the first spring 218 places against the first actuation pushrod 230 by an amount that is proportional to the first distance. This moves the first actuation pushrod 230 into the first brake master cylinder 232 and increases the first brake fluid pressure in proportion to the first distance.

Rotating the steering shaft 202 in the second direction 250 applies the steering force that rotates a second side 214 of the steering arm 210 towards a first end 226 of second spring 224 to compress the second spring 224 against the second actuation pushrod 234 of the second brake master cylinder 236 to move the second actuation pushrod 234 to generate a second brake fluid pressure. If the steering shaft 202 is rotated by a certain amount of rotation in the second direction 250, second spring 224 is linearly compressed by a second distance that is proportional to the amount of rotation. This increases the force that the second spring 224 places against the second actuation pushrod 234 by an amount that is proportional to the second distance. This moves the second actuation pushrod 234 into the first brake master cylinder 232 and increases the first brake fluid pressure in proportion to the first distance.

ATV 100 includes a right disc brake on a right side of ATV 100 that operates and is in fluid communication with the first brake master cylinder 232. ATV 100 includes a left side disc brake on a left side of the ATV 100 that operates and is in fluid communication with the second brake master cylinder 236. Rotating handlebar 204 in direction 242 to rotate steering shaft 202 in the first direction 244 or the clockwise direction applies a braking force via the generated first brake fluid pressure to the right side disc brake on ATV 100. Rotating handlebar 204 in direction 248 to rotate steering shaft 202 in the second direction 250 or the counter-clockwise direction applies a braking force via the generated second brake fluid pressure to the left side disc brake on ATV 100.

ATV 100 includes a transmission 700 or a transmission 800 (See also, FIGS. 7 and 8). Transmission 700 or 800 includes a right side drive shaft mechanically coupled to the right side disk brake and to the three or more wheels 104 on the right side of the ATV 100. Transmission 700 or 800 includes a left side drive shaft mechanically coupled to the left side disk brake and to the three or more wheels 106 on the left side of ATV 100.

In the illustrated embodiment, applying the braking force to the right side disc brake causes transmission 700 or 800 to increase a rotational speed of the left side drive shaft of transmission 700 or 800 and thus a rotational speed of the three or more wheels 106 on the left side of ATV 100 as a ratio of a reduction in rotational speed of the right side drive shaft due to the braking force applied to the right side disc brake and the corresponding reduction in rotational speed of the three or more wheels 104 on the right side of ATV 100. Applying the braking force to the left side disc brake causes transmission 700 or 800 to increase a rotational speed of the right side drive shaft and thus a rotational speed of the three or more wheels 104 on the right side of the ATV 100 as the ratio of the reduction in the rotational speed of the left side drive shaft resulting from the braking force applied to the left side disc brake and the corresponding reduction in rotational speed of the three or more wheels 106 on the left side of ATV 100.

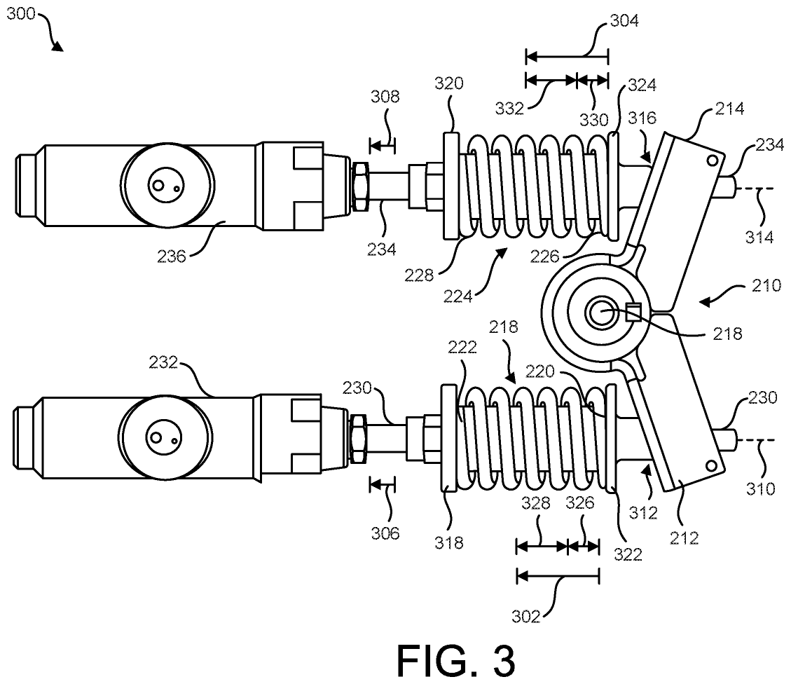

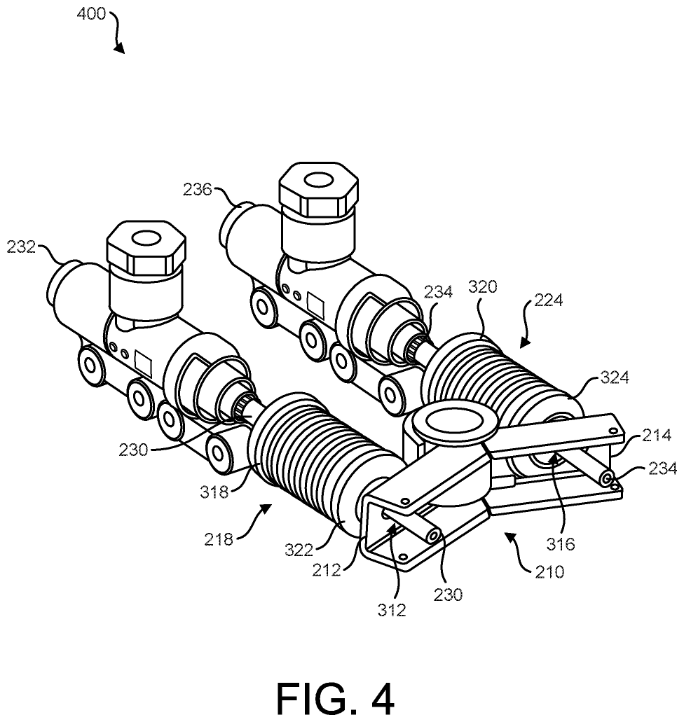

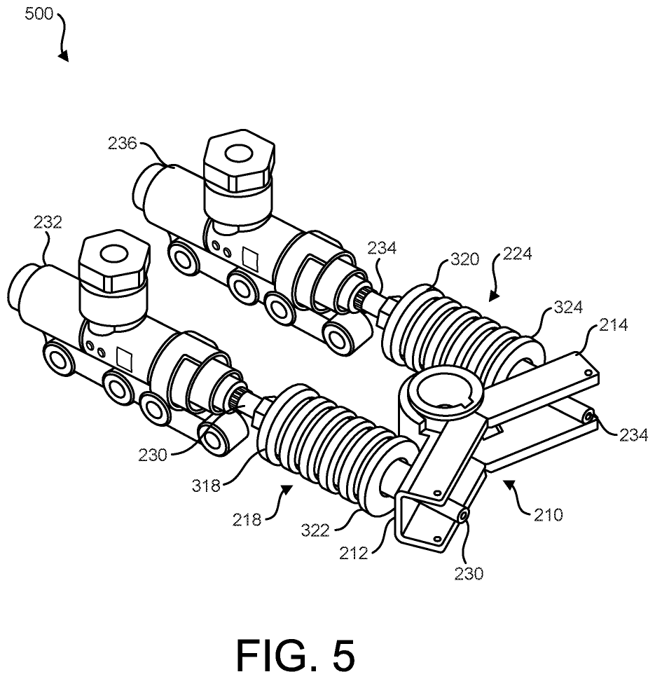

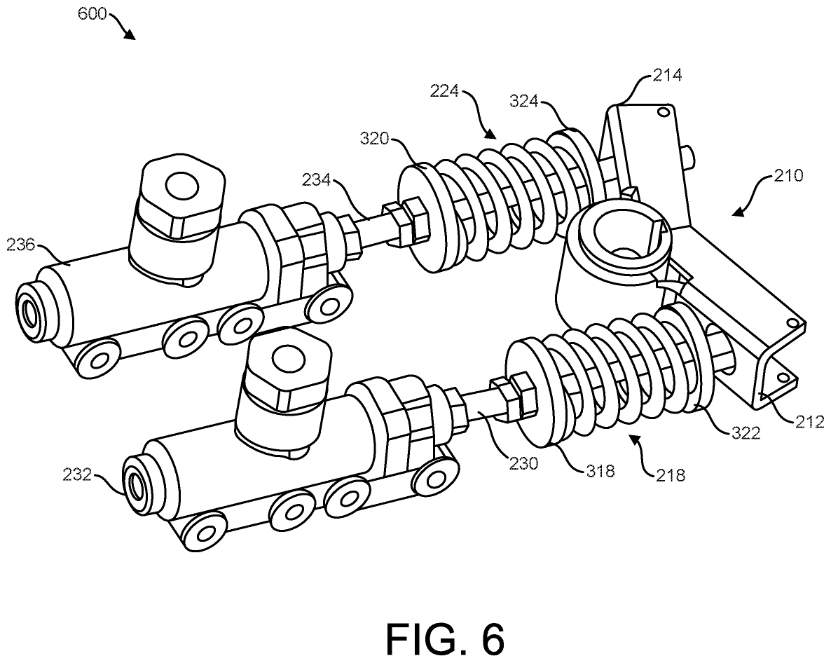

FIG. 3 illustrates an embodiment of a top view of a steering system located between handlebar 204 and a brake system that includes a right side disk brake and a left side disk brake. FIGS. 4-6 illustrate embodiments of perspective views of a steering system located between handlebar 204 and the brake system respectively at 400, 500 and 600. Referring to FIGS. 2-6, the first spring 218 and the second spring 224 each have a maximum spring compression distance illustrated as a linear distance respectively at 302 and 304. Arrow 302 indicates a direction of compression of first spring 218 and arrow 304 indicates a direction of compression of second spring 224. The first actuation pushrod 230 and the second actuation pushrod 234 each have a maximum pushrod travel distance illustrated as a linear distance respectively at 306 and 308. Arrow 306 indicates a direction of movement of first actuation pushrod 230 into first brake master cylinder 232 and arrow 308 indicates a direction of movement of second actuation pushrod 234 into second brake master cylinder 236.

In the illustrated embodiment, maximum spring compression distance illustrated at 302 and 304 is three or more times greater than the maximum pushrod travel distance illustrated respectively at 306 and 308 for first actuation pushrod 230 and second actuation pushrod 234. By including spring mechanism 216 which includes first spring 218 and second spring 224, an increase of 4 times or more of a wider range of steering motion is achieved which provides very smooth turning for ATV 100, even with tight turning radiuses.

In the illustrated embodiment, using first spring 218 to apply the steering force against first actuation pushrod 230 and using second spring 224 to apply the steering force against second actuation pushrod 234 provides a progressive dual-rate steering system. First spring 218 and second spring 224 are open-coil helical compression springs. First spring 218 and second spring 224 each have a spring constant k, and a force applied to first actuation pushrod 230 by first spring 218 or a force applied to second actuation pushrod 234 by second spring 224 scales linearly with an amount or distance of compression of first spring 218 or second spring 224 up to the maximum spring compression distance illustrated respectively at 302 and 304. The force required to move the first actuation pushrod 230 into the first brake master cylinder 232 to increase the first brake fluid pressure, or to move the second actuation pushrod 234 into the second brake master cylinder 236 to increase the second brake fluid pressure, is less that the force applied at the maximum compression distance 302 and 304 respectively by first spring 218 and second spring 224.

In the illustrated embodiment, the first brake master cylinder 232 and the second brake master cylinder 236 are mounted on ATV 100 in a parallel arrangement. First actuation pushrod 230 has an axis 310 and is in axial alignment with an opening 312 on the first side 212 of the steering arm 210. An end of first actuation pushrod extends 230 through opening 312. The second actuation pushrod 234 has an axis 314 and is in axial alignment with an opening 316 on the second side 214 of the steering arm 210. The second actuation pushrod 234 extends through opening 316.

In the illustrated embodiment, a first spring support 318 is attached or fixed to the first actuation pushrod 230 and holds or secures a second end 222 of first spring 218 in alignment with the first actuation pushrod 230. First actuation pushrod 230 extends through an inside diameter of first spring 218 and through the opening 312 on the first side 212 of steering arm 212. The opening 312 on the first side 212 of steering arm 210 has a diameter that is greater than a diameter of the first actuation pushrod 230. A second spring support 320 is attached or fixed to the second actuation pushrod 234 and holds or secures a second end 228 of the second spring 224 in alignment with the second actuation pushrod 234. Second actuation pushrod 234 extends through an inside diameter of second spring 224 and through the opening 316 on the second side 214 of steering arm 210. The opening 316 on the second side 214 of steering arm 210 has a diameter that is greater than a diameter of the second actuation pushrod 234.

In the illustrated embodiment, a first bullnose washer 322 has an inner opening that is larger than the diameter of the first actuation pushrod 230. This allows the first bullnose washer 322 to slide in an axial direction along an axis 310 of the first actuation pushrod 230. The first actuation pushrod 230 extends through the inner opening of the first bullnose washer 314. The first bullnose washer 314 has a hemispherical nose portion and a base portion and is positioned on the first actuation pushrod 230 between the first side 212 of the steering arm 210 and the first end 230 of the first spring 218. A diameter of opening 312 on the first side 212 of the steering arm 210 is large enough to at least partially accommodate the hemispherical nose portion of the first bullnose washer 314. The base portion of the first bullnose washer 322 has an outside diameter that is equal to or greater than an outside diameter of the first spring 218.

A second bullnose washer 324 has an inner opening that is larger than the diameter of the second actuation pushrod 234. This allows the second bullnose washer 324 to slide in an axial direction along an axis 314 of the second actuation pushrod 234. The second actuation pushrod 234 extends through the inner opening of the second bullnose washer 324. The second bullnose washer 324 has a hemispherical nose portion and a base portion and is positioned on the second actuation pushrod 234 between the second side 214 of the steering arm 210 and the first end 226 of the second spring 224. A diameter of the opening 316 on the second side 214 of the steering arm 210 is large enough to at least partially accommodate the hemispherical nose portion of the second bullnose washer 324. The base portion of the second bullnose washer 324 has an outside diameter that is equal to or greater than an outside diameter of the second spring 224.

In the illustrated embodiment, first bullnose washer 322 and second bullnose washer 324 are formed from a low-carbon steel. In this embodiment, the low-carbon steel consists of less than 0.30% of carbon. In other embodiments, a medium-carbon steel with 0.30% to 0.60% of carbon, or a high-carbon steel with more than 0.60% carbon can be used. In other embodiments, first bullnose washer 322 and second bullnose washer 324 can be formed from other suitable materials.

In the illustrated embodiment, rotating the handlebar 204 by applying a steering force at the left grip or first side grip 240 rotates handlebar 204 in a direction 242 which rotates the steering shaft 202 in the first direction 244. Rotating the steering shaft 202 in the first direction 244 rotates the first side 212 of the steering arm 210 towards the first brake master cylinder 232. The first side 212 of the steering arm 210 pushes the first bullnose washer 322 into the first spring 218 in the direction illustrated at 302 and compresses the first spring 218 against the first spring support 318 which is attached to the first actuation pushrod 230. The force against the first spring support 318 due to the compression of first spring 218 moves the first actuation pushrod 230 into the first brake master cylinder 232 in the direction illustrated at 302 and causes the first brake master cylinder 232 to generate the first brake fluid pressure. In operation, the steering force path is handlebar 204>steering shaft 202>steering arm 210>first bullnose washer 322>first spring 218>first actuation pushrod 230.

Rotating the handlebar 204 by applying a steering force at the right grip or second side grip 246 rotates handlebar 204 in a direction 248 which rotates the steering shaft 202 in the second direction 250. Rotating the steering shaft 202 in the second direction 250 rotates the second side 214 of the steering arm 210 towards the second brake master cylinder 236. The second side 214 of the steering arm 210 pushes the second bullnose washer 324 into the second spring 224 and compresses the second spring 224 against the second spring support 320 which is attached to the second actuation pushrod 234. The force against the second spring support 320 due to the compression of second spring 224 moves the second actuation pushrod 234 in the direction illustrated at 304 into the second brake master cylinder 236 and causes the second brake master cylinder 236 to generate the second brake fluid pressure. In operation, the steering force path is handlebar 204>steering shaft 202>steering arm 210>second bullnose washer 324>second spring 224>second actuation pushrod 234.

In the illustrated embodiment, when the steering shaft 202 is rotated in the first direction 244, the force against the first spring support 318 due to the compression of first spring 218 moves the first actuation pushrod 230 in the direction illustrated at 302 by a portion 326 of first distance 302 before the first actuation pushrod 230 is moved into the first brake master cylinder 232 to generate the first brake fluid pressure. This is because the force applied to first actuation pushrod 230 by first spring 218 for an amount of compression of first spring 218 as illustrated at 326 is insufficient to move the first actuation pushrod 230. With further compression of first spring 218 in direction 302 as illustrated at 328, the force applied to first actuation pushrod 230 by first spring 218, which scales linearly with the amount or distance of compression of first spring 218, is sufficient to move the first actuation pushrod 230 into the first brake master cylinder 232 and cause the first brake master cylinder 232 to generate the first brake fluid pressure.

In the illustrated embodiment, when the steering shaft 202 is rotated in the second direction 250, the force against the second spring support 320 due to the compression of second spring 224 moves the second actuation pushrod 234 in the direction illustrated at 304 by a portion 330 of first distance 304 before the second actuation pushrod 234 is moved into the second brake master cylinder 236 to generate the second brake fluid pressure. This is because the force applied to second actuation pushrod 234 by second spring 224 for an amount of compression of second spring 224 as illustrated at 330 is insufficient to move the second actuation pushrod 234. With further compression of second spring 224 in direction 304 as illustrated at 332, the force applied to second actuation pushrod 234 by second spring 224, which scales linearly with the amount or distance of compression of second spring 224, is sufficient to move the second actuation pushrod 234 into the second brake master cylinder 236 and cause the second brake master cylinder 236 to generate the second brake fluid pressure.

In an alternative embodiment, first spring 218 and second spring 224 are each dual-rate springs. In this embodiment, the dual rate spring has a first spring length with a first spring constant k and a second spring length with a second spring constant k that is higher than the first spring constant. With compression, the dual-rate spring provides a first force through a first portion of compression, and transitions to a higher second force through a second portion of compression. The use of a dual rate spring 1400 for first spring 218 and second spring 224 may provide better control of the force applied to the first actuation pushrod 230 by first spring 218, and better control of the force applied to the second actuation pushrod 234 by second spring 224.

FIG. 7 illustrates an embodiment at 700 of a transmission used as part of a braking system having a progressive steering system. The transmission 700 is used in a manner similar to a skid steering system and provides for increased maneuverability (i.e. a zero-turn radius). Transmission 700 uses an open type output differential. Drive power from an engine (not illustrated) is applied directly or indirectly to an engine shaft of transmission 700. The drive power passes through the transmission 700 from the engine to a right side drive shaft on a right side of transmission 700 and to a left side drive shaft on a left side of transmission 700. When steering, a braking force is applied to the right side drive shaft or to the left side drive shaft of transmission 700. The braking force causes the braked side of transmission 700 to slow and the speed of the other side to increase proportionally. Because the brakes are acting directly on the differential outputs or the right side drive shaft or the left side drive shaft, an effort required to turn ATV 100 is greater that is required with transmission 800 (see also, FIG. 8). More power is used during steering events when using transmissions such as transmission 700.

FIG. 8 illustrates an embodiment 800 of a triple differential transmission used as part of a braking system having a progressive steering system. Transmission 800 is contained in a transmission housing 802. Drive power from an engine (not illustrated) is applied directly or indirectly to an engine shaft 804 of transmission 800. The drive power passes through the transmission 800 from the engine to engine shaft 804 to the right side drive shaft 806 and the left side drive shaft 808. A right side brake disc 810 is mechanically attached to and rotates with right side drive shaft 806, and a left side brake disc 812 is mechanically attached to and rotates with left side drive shaft 808. The three differentials are used for steering, a left side output or left side drive shaft, and a right side output or right side drive shaft. The left side output and the right side output differentials are planetary type. Steering brakes do not directly act on the output shafts but on the steering differential. The steering differential then acts as an input to the planetary output differentials to alter the output shaft speed from left to right. Because the steering brake application is transmitted through several gear sets the engine power requirement for steering is reduced.

FIG. 8 illustrates an embodiment at 800 of a triple differential transmission used as part of a braking system having a progressive steering system. Transmission 800 is contained in a transmission housing 802. Drive power from an engine (not illustrated) is applied directly or indirectly to an engine shaft input (not illustrated) of transmission 800. The drive power passes through transmission 800 from the engine shaft input to a left wheel shaft 804 and a right wheel shaft (not illustrated). A right side brake disc 810 is mechanically attached to and rotates with a right side steer shaft 806, and a left side brake disc 812 is mechanically attached to and rotates with a left side steer shaft 808. Three differentials are used for steering, for a left side output for left wheel shaft 804, and for a right side output for right side steer shaft 806. The left side output and the right side output differentials are planetary type. The steering brakes do not act directly on the left wheel shaft 804 and the right wheel shaft but rather on the right side brake disc 810 and the right side steer shaft 806, and the left side brake disc 812 and the left side steer shaft 808. The steering differential acts as an input to the planetary output differentials to alter the left wheel shaft 804 and the right wheel shaft to change a direction of ATV 100 from left to right. Because the steering brake application is transmitted through several gear sets, the engine power requirement for steering is reduced.

With transmission 800, the application of a braking force to the left side brake disc 812 will decrease a rotational speed of the right side wheel shaft and will increase a rotational speed of the left side wheel shaft 804. The application of a braking force to the right side brake disc 810 will decrease a rotational speed of the left side wheel shaft 804 and will increase a rotational speed of the right side wheel shaft.

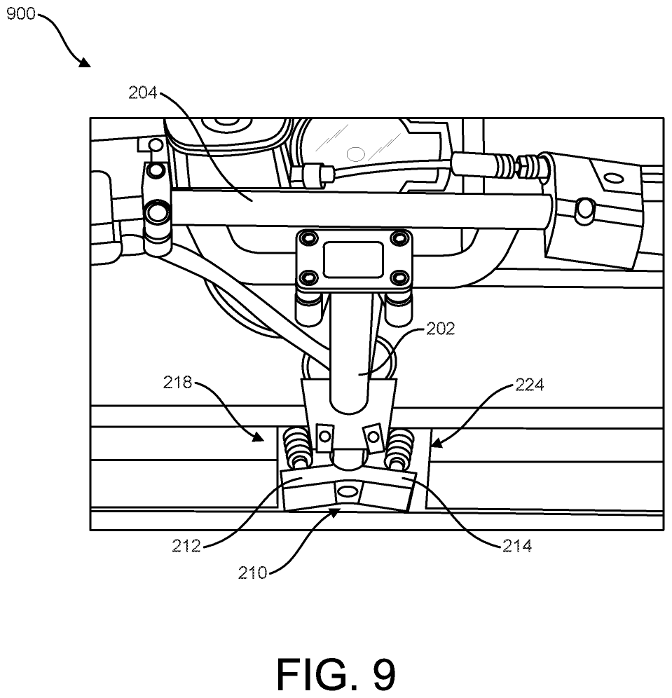

FIG. 9 illustrates an embodiment of a perspective view of a progressive steering system for ATV 100. In FIG. 9, handlebar 204 is not rotated and a braking force is not being applied to the right side wheels 104 and to the left side wheels 106.

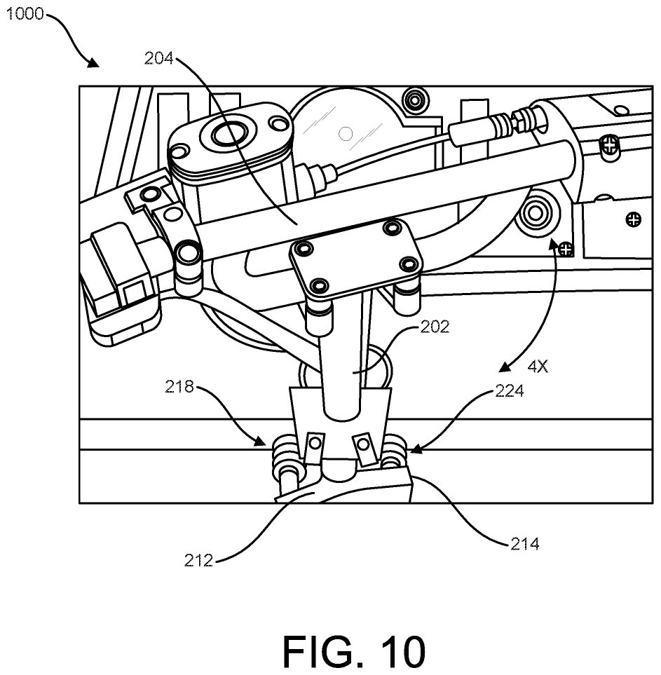

FIG. 10 illustrates an embodiment of a perspective view of a progressive steering system for ATV 100 that illustrates a counter-clockwise turn of the steering handle 204. Second spring 224 is at a maximum spring compression distance 304. The maximum spring compression distance 304 is three or more times greater than the maximum pushrod travel distance which provides an increase of 4 times or more of a wider range of steering motion.

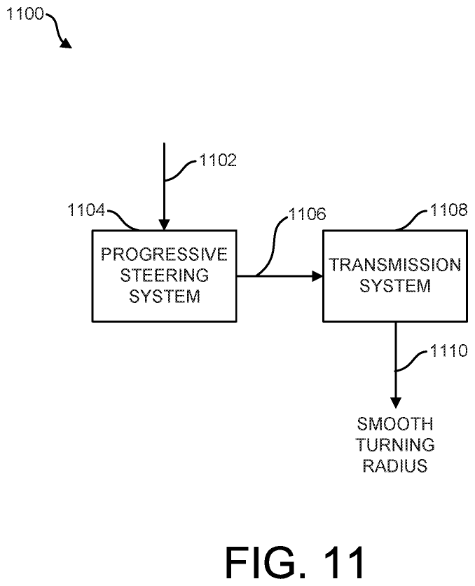

FIG. 11 illustrates an embodiment of a method of operating an ATV with a progressive steering system. FIG. 11 illustrates how a progressive steering system helps to achieve a progressive dual-rate steering system. The steering system is operated by initial activation of the progressive steering system via operation of handlebar 204. The initial steering rate is associated with the spring mechanism 216 located between the handlebars and the brake system. Once started, the progressive steering system 1102 illustrates the steering force path of handlebar 204>steering shaft 202>steering arm 210>first bullnose washer 322>first spring 218>first actuation pushrod 230, or the steering force path of handlebar 204>steering shaft 202>steering arm 210>second bullnose washer 324>second spring 224>second actuation pushrod 234 (See also, FIGS. 2-6). At 1104, when a braking force is applied to the right side drive shaft or to the left side drive shaft of transmission 700 or 800, the braking force causes the braked side of transmission 700 or 800 to slow and the speed of the other side to increase proportionally resulting in a smooth turning radius as illustrated at 1106 (See also, FIGS. 7 and 8).

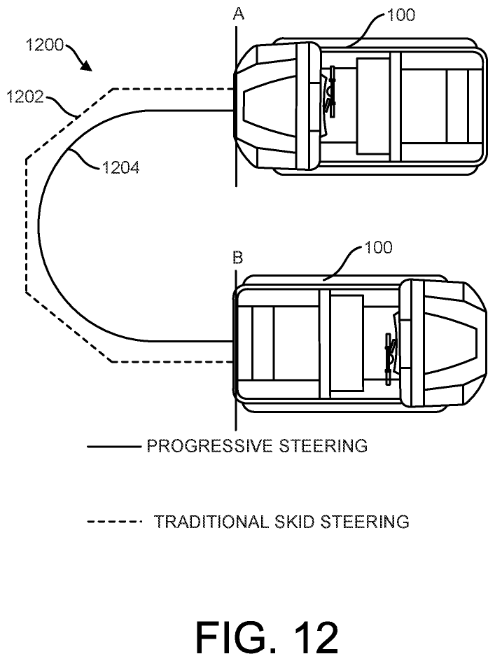

FIG. 12 illustrates an embodiment of a schematic illustrating a smooth driving radius of an ATV having a progressive steering system. ATV 100 is attempting to make a tight turn from point A to point B. Dashed line 1202 illustrates the jerky path of an ATV 100 using a traditional skid steer type steering system with spring mechanism 216. Solid line 1204 illustrates the smooth path of an ATV 100 having a progressive steering system with spring mechanism 216. The progressive steering system is a dual rate steering system (See also, FIGS. 2-6). The progressive steering system works with the braking/transmission system to achieve a smooth turning. In one example, the progressive steering system works with a skid steering system having a transmission that uses an open output type differential. In another example, the progressive steering system works with other braking/transmission systems, such as a transmission that uses multiple differentials where the outputs are planetary type. Embodiments of transmissions are illustrated in FIGS. 7 and 8.

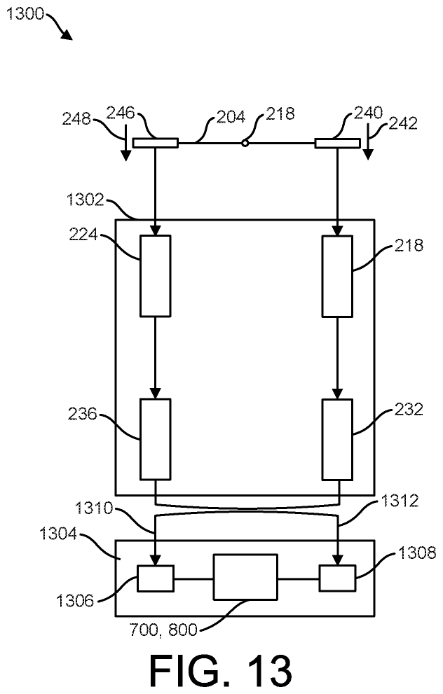

FIG. 13 illustrates an embodiment at 1300 of a diagram illustrating a dual-rate progressive steering system for ATV 100. The dual-rate progressive steering system is operated by initial activation of a handlebar 204. Handlebar 204 is attached at a top end 206 of the steering shaft 202, and a steering arm 210 is attached at a bottom end 208 of the steering shaft 202 (See also, FIGS. 2 and 3). Steering arm 210 rotates with the steering shaft 202 and includes a first side 212 and a second side 214. The steering shaft 202 and the steering arm 210 are configured to rotate by a steering torque input from the handlebar 204.

A first steering system 1302 includes first brake master cylinder 232 with a first spring 218 and a second brake master cylinder 236 with a second spring 224. The first spring couples the first side 212 of the steering arm 202 to a first actuation pushrod 230 of the first brake master cylinder 232. The second spring 224 couples the second side 214 of the steering arm 210 to a second actuation pushrod 234 of the second brake master cylinder 236.

A second steering system 1304 includes a transmission 700 or 800 that has a right side drive shaft and a left side drive shaft, or a right side wheel shaft and a left side wheel shaft (See also, FIGS. 7 and 8). The right side drive shaft or the right side wheel shaft is coupled to a right side disk brake 1306 that is in fluid communication with the first brake master cylinder 232 as illustrated at 1310. The left side drive shaft or the left side wheel shaft is coupled to a left side disk brake 1308 that is in fluid communication with the second brake master cylinder 236 as illustrated at 1312

In the illustrated embodiment, first steering system 1302 provides a first turning rate when rotating the steering shaft 202 by an amount of rotation in a first direction 244 by compressing the first spring 218 to move the first actuation pushrod 230 into the first brake master cylinder 232 to increase a first brake fluid pressure to apply a braking force to the right disk brake 1306 or the left side brake disk 1308. First steering system 1302 provides a first turning rate when rotating the steering shaft 202 by an amount of rotation in a second direction 250 by compressing the second spring 224 to move the second actuation pushrod 234 into the second brake master cylinder 236 to increase the second brake fluid pressure to apply a braking force to the left side disk brake 1308 or the right side brake disk 1306.

In one embodiment, the second steering system 1304 provides a second turning rate when the braking force is applied to the right side disc brake 1306 by causing transmission 700 to increase a rotational speed of the left side drive shaft of the transmission 700 as a ratio of a reduction in rotational speed of the right side drive shaft. The second steering system 1304 provides the second turning rate when the braking force is applied to the left side disc brake 1308 by causing the transmission 700 to increase a rotational speed of the right side drive shaft of the transmission 700 as a ratio of a reduction in rotational speed of the left side drive shaft.

In another embodiment, the second steering system 1304 provides a second turning rate when the braking force is applied to the left side disc brake 1308 by causing transmission 800 to decrease a rotational speed of the right side wheel shaft of the transmission 800 as a ratio of an increase in rotational speed of the left side wheel shaft of transmission 800. The second steering system 1304 provides a second turning rate when the braking force is applied to the right side disc brake 1306 by causing transmission 800 to decrease a rotational speed of the left side wheel shaft of the transmission 800 as a ratio of an increase in rotational speed of the right side wheel shaft of transmission 800.

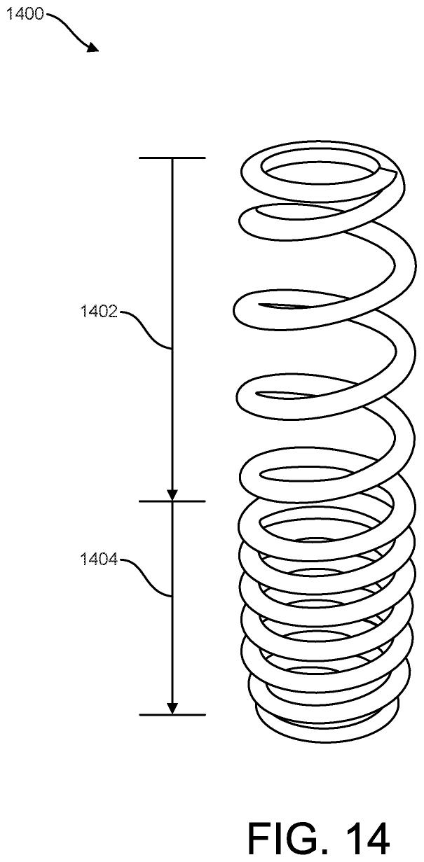

FIG. 14 illustrates an embodiment at 1400 of a dual-rate spring for a progressive steering system for an ATV 100. The dual rate spring 1400 has a first spring length at 1402 with a first spring constant k and a second spring length at 1404 with a second spring constant k that is higher than the first spring constant. With compression, spring 1400 provides a first force through the first portion of compression at 1402, and transitions to a higher second force through the second portion of deflection illustrated at 1404. In alternative embodiments, use of a dual rate spring 1400 for first spring 218 and second spring 224 may provide better control of the force applied to the first actuation pushrod 230 by first spring 218, and better control of the force applied to the second actuation pushrod 234 by second spring 224 (See also, FIGS. 2 and 3).

What is claimed is:

1. A progressive brake steering system for a vehicle, comprising:
a steering shaft configured to rotate by a steering torque input from a steering device;
a steering arm that is attached to the steering shaft and configured to rotate with the steering shaft;
a spring mechanism coupling the steering arm to a first actuation pushrod of a first brake master cylinder and a second actuation pushrod of a second brake master cylinder, wherein the axis of the steering shaft is medially offset from the first actuation pushrod and the second actuation pushrod,
wherein rotating the steering shaft in a first direction applies a steering force that rotates a first side of the steering arm towards a first end of a first spring of the spring mechanism to compress the first spring against the first actuation pushrod of the first brake master cylinder to move the first actuation pushrod to generate a first brake fluid pressure, and
wherein rotating the steering shaft in a second direction applies the steering force that rotates a second side of the steering arm towards a first end of a second spring of the spring mechanism to compress the second spring against the second actuation pushrod of the second brake master cylinder to move the second actuation pushrod to generate a second brake fluid pressure.

2. The progressive brake steering system of claim 1, wherein the first spring and the second spring each have a maximum spring compression distance, wherein the first actuation pushrod and the second actuation pushrod each have a maximum pushrod travel distance, and wherein the maximum spring compression distance is three or more times greater than the pushrod travel distance.

3. The progressive brake steering system of claim 1, wherein
rotating the steering shaft by an amount of rotation in the first direction linearly compresses the first spring by a first distance that is proportional to the amount of rotation in the first direction thereby increasing a force that the first spring places against the first actuation pushrod by an amount that is proportional to the first distance to move the first actuation pushrod into the first brake master cylinder to increase the first brake fluid pressure in proportion to the first distance, and
rotating the steering shaft by an amount of rotation in the second direction linearly compresses the second spring by a second distance that is proportional to the amount of rotation in the second direction thereby increasing a force that the second spring places against the second actuation pushrod by an amount that is proportional to the second distance to move the second actuation pushrod into the second brake master cylinder to increase the second brake fluid pressure in proportion to the second distance.

4. The progressive brake steering system of claim 3,
wherein rotating the steering shaft by the amount of rotation in the first direction to compress the first spring by the first distance comprises compressing the first spring by a portion of the first distance before the first actuation pushrod is moved into the first brake master cylinder to increase the first brake fluid pressure, and
wherein rotating the steering shaft by the amount of rotation in the second direction to compress the second spring by the second distance comprises compressing the second spring by a portion of the second distance before the second actuation pushrod is moved into the second brake master cylinder to increase the second brake fluid pressure.

5. The progressive brake steering system of claim 1, further comprising
a first spring support fixed to the first actuation pushrod and configured to hold a second end of the first spring in alignment with the first actuation pushrod such that the first actuation pushrod extends through an inside diameter of the first spring and through an opening on the first side of the steering arm, wherein the opening on the first side of the steering arm has a diameter that is greater than a diameter of the first actuation pushrod, and
a second spring support fixed to the second actuation pushrod and configured to hold a second end of the second spring in alignment with the second actuation pushrod such that the second actuation pushrod extends through an inside diameter of the second spring and through an opening on the second side of the steering arm, wherein the opening on the second side of the steering arm has a diameter that is greater than a diameter of the second actuation pushrod.

6. The progressive brake steering system of claim 5, further comprising:
a first bullnose washer having an inner opening that is larger than the diameter of the first actuation pushrod, wherein the first actuation pushrod extends through the inner opening of the first bullnose washer, wherein the first bullnose washer has a hemispherical nose portion and a base portion and is positioned on the first actuation pushrod between the first side of the steering arm and the first end of the first spring, wherein the diameter of the opening on the first side of the steering arm is large enough to at least partially accommodate the hemispherical nose portion of the first bullnose washer, and wherein the base portion of the first bullnose washer has an outside diameter that is equal to or greater than an outside diameter of the first spring, and
a second bullnose washer having an inner opening that is larger than the diameter of the second actuation pushrod, wherein the second actuation pushrod extends through the inner opening of the second bullnose washer, wherein the second bullnose washer has a hemispherical nose portion and a base portion and is positioned on the second actuation pushrod between the second side of the steering arm and the first end of the second spring, wherein the diameter of the opening on the second side of the steering arm is large enough to at least partially accommodate the hemispherical nose portion of the second bullnose washer, and wherein the base portion of the second bullnose washer has an outside diameter that is equal to or greater than an outside diameter of the second spring.

7. The progressive brake steering system of claim 6,
wherein rotating the steering shaft in the first direction comprises rotating the first side of the steering arm towards the first brake master cylinder to push the first bullnose washer into the first spring to compress the first spring against the first spring support to move the first actuation pushrod into the first brake master cylinder to generate the first brake fluid pressure, and
wherein rotating the steering shaft in the second direction comprises rotating the second side of the steering arm towards the second brake master cylinder to push the second bullnose washer into the second spring to compress the second spring against the second spring support to move the second actuation pushrod into the second brake master cylinder to generate the second brake fluid pressure.

8. The progressive brake steering system of claim 1, wherein the first spring and the second spring are open-coil helical compression springs.

9. The progressive brake steering system of claim 1, wherein the vehicle further comprises a right disc brake on a right side of the vehicle and a left side disc brake on a left side of the vehicle, wherein the first brake master cylinder is in fluid communication with the right side disc brake and the second brake master cylinder is in fluid communication with the left side disc brake, wherein rotating the steering shaft in the first direction to generate the first brake fluid pressure comprises rotating the steering shaft in a clockwise direction to apply a braking force to the right side disc brake on the vehicle, and wherein rotating the steering shaft in the second direction to generate the second brake fluid pressure comprises rotating the steering shaft in a counter-clockwise direction to apply a braking force to the left side disc brake on the vehicle.

10. The progressive brake steering system of claim 9, wherein the vehicle further comprises a transmission that includes a right side drive shaft mechanically coupled to the right side disk brake and to at least one wheel on the right side of the vehicle and a left side drive shaft mechanically coupled to the left side disk brake and to at least one wheel on the left side of the vehicle,
wherein applying the braking force to the right side disc brake comprises the transmission increasing a rotational speed of the left side drive shaft and a rotational speed of the at least one wheel on the left side of the vehicle as a ratio of a reduction in rotational speed of the right side drive shaft resulting from the braking force applied to the right side disc brake and a corresponding reduction in rotational speed of the at least one wheel on the right side of the vehicle, and
wherein applying the braking force to the left side disc brake comprises the transmission increasing the rotational speed of the right side drive shaft and the rotational speed of the at least one wheel on the right side of the vehicle as the ratio of the reduction in the rotational speed of the left side drive shaft resulting from the braking force applied to the left side disc brake and the corresponding reduction in rotational speed of the at least one wheel on the left side of the vehicle.

11. The progressive brake steering system of claim 1, wherein the first spring and the second spring each have a spring constant k.

12. The progressive brake steering system of claim 1, wherein the first spring and the second spring each are a dual-rate spring that have a first spring constant k and a second spring constant k, wherein the second spring constant k is higher than the first spring constant k.

13. An All-Terrain Vehicle (ATV) with a progressive brake steering system, comprising:
a steering shaft that includes a handlebar attached at a top end and a steering arm attached at a bottom end, wherein the steering arm includes a first side and a second side, wherein the steering shaft and the steering arm are configured to rotate by a steering torque input from the handlebar;
a first brake master cylinder and a second brake master cylinder;
a spring mechanism that includes a first spring and a second spring, the first spring coupling the first side of the steering arm to a first actuation pushrod of the first brake master cylinder, the second spring coupling the second side of the steering arm to a second actuation pushrod of the second brake master cylinder, wherein
an axis of the steering shaft is medially offset from the first actuation pushrod and the second actuation pushrod;
a right disc brake on a right side of the ATV in fluid communication with the first brake master cylinder and a left side disc brake on a left side of the ATV in fluid communication with the second brake master cylinder;
three or more wheels on the right side of the ATV and three or more wheels on the left side of the ATV; and
a transmission that includes a right side drive shaft mechanically coupled to the right side disk brake and to the three or more wheels on the right side of the ATV and a left side drive shaft mechanically coupled to the left side disk brake and to the three or more wheels on the left side of the ATV.

14. The ATV of claim 13, wherein the first brake master cylinder and the second brake master cylinder are mounted on the ATV in a parallel arrangement, wherein the first actuation pushrod is in axial alignment with the opening on the first side of the steering arm, and wherein the second actuation pushrod is in axial alignment with the opening on the second side of the steering arm.

15. The ATV of claim 13, wherein
rotating the handlebar by an amount of rotation in the first direction linearly compresses the first spring by a first distance that is proportional to the amount of rotation in the first direction thereby increasing a force that the first spring places against the first actuation pushrod by an amount that is proportional to the first distance to move the first actuation pushrod into the first brake master cylinder to increase the first brake fluid pressure in proportion to the first distance, and
rotating the handlebar by an amount of rotation in the second direction linearly compresses the second spring by a second distance that is proportional to the amount of rotation in the second direction thereby increasing a force that the second spring places against the second actuation pushrod by an amount that is proportional to the second distance to move the second actuation pushrod into the second brake master cylinder to increase the second brake fluid pressure in proportion to the second distance.

16. The ATV of claim 15, wherein
wherein rotating the handlebar by the amount of rotation in the first direction to compress the first spring by the first distance comprises compressing the first spring by a portion of the first distance before the first actuation pushrod is moved into the first brake master cylinder to increase the first brake fluid pressure, and
wherein rotating the handlebar by the amount of rotation in the second direction to compress the second spring by the second distance comprises compressing the second spring by a portion of the second distance before the second actuation pushrod is moved into the second brake master cylinder to increase the second brake fluid pressure.

17. The ATV of claim 13, further comprising
a first spring support fixed to the first actuation pushrod and configured to hold a second end of the first spring in alignment with the first actuation pushrod such that the first actuation pushrod extends through an inside diameter of the first spring and through an opening on the first side of the steering arm, wherein the opening on the first side of the steering arm has a diameter that is greater than a diameter of the first actuation pushrod, and
a second spring support fixed to the second actuation pushrod and configured to hold a second end of the second spring in alignment with the second actuation pushrod such that the second actuation pushrod extends through an inside diameter of the second spring and through an opening on the second side of the steering arm, wherein the opening on the second side of the steering arm has a diameter that is greater than a diameter of the second actuation pushrod.

18. The ATV of claim 17, further comprising:
a first bullnose washer having an inner opening that is larger than the diameter of the first actuation pushrod, wherein the first actuation pushrod extends through the inner opening of the first bullnose washer, wherein the first bullnose washer has a hemispherical nose portion and a base portion and is positioned on the first actuation pushrod between the first side of the steering arm and the first end of the first spring, wherein the diameter of the opening on the first side of the steering arm is large enough to at least partially accommodate the hemispherical nose portion of the first bullnose washer, and wherein the base portion of the first bullnose washer has an outside diameter that is equal to or greater than an outside diameter of the first spring, and
a second bullnose washer having an inner opening that is larger than the diameter of the second actuation pushrod, wherein the second actuation pushrod extends through the inner opening of the second bullnose washer, wherein the second bullnose washer has a hemispherical nose portion and a base portion and is positioned on the second actuation pushrod between the second side of the steering arm and the first end of the second spring, wherein the diameter of the opening on the second side of the steering arm is large enough to at least partially accommodate the hemispherical nose portion of the second bullnose washer, and wherein the base portion of the second bullnose washer has an outside diameter that is equal to or greater than an outside diameter of the second spring.

19. The ATV of claim 18,
wherein rotating the handlebar in the first direction comprises rotating the first side of the steering arm towards the first brake master cylinder to push the first bullnose washer into the first spring to compress the first spring against the first spring support to move the first actuation pushrod into the first brake master cylinder to generate the first brake fluid pressure, and
wherein rotating the handlebar in the second direction comprises rotating the second side of the steering arm towards the second brake master cylinder to push the second bullnose washer into the second spring to compress the second spring against the second spring support to move the second actuation pushrod into the second brake master cylinder to generate the second brake fluid pressure.

20. The ATV of claim 13, wherein the first spring and the second spring each are open-coil helical compression springs.

21. The ATV of claim 19, wherein rotating the steering handlebar in the first direction to generate the first brake fluid pressure comprises rotating the steering shaft in a clockwise direction to apply a braking force to the right side disc brake on the ATV, wherein applying the braking force to the right side disc brake comprises the transmission increasing a rotational speed of the left side drive shaft and a rotational speed of the three or more wheels on the left side of the ATV as a ratio of a reduction in rotational speed of the right side drive shaft resulting from the braking force applied to the right side disc brake and a corresponding reduction in rotational speed of the three or more wheels on the right side of the ATV,
wherein rotating the handlebar in the second direction to generate the second brake fluid pressure comprises rotating the handlebar in a counter-clockwise direction to apply a braking force to the left side disc brake on the ATV, and wherein applying the braking force to the left side disc brake comprises the transmission increasing the rotational speed of the right side drive shaft and the rotational speed of the three or more wheels on the right side of the vehicle as the ratio of the reduction in the rotational speed of the left side drive shaft resulting from the braking force applied to the left side disc brake and the corresponding reduction in rotational speed of the three or more wheels on the left side of the vehicle.

22. A dual-rate steering system for an All-Terrain Vehicle (ATV), comprising:
a steering shaft that includes a handlebar attached at a top end and a steering arm attached at a bottom end, wherein the steering arm includes a first side and a second side, wherein the steering shaft and the steering arm are configured to rotate by a steering torque input from the handlebar;
a first steering system comprising a first brake master cylinder that includes a first spring and a second brake master cylinder that includes a second spring, the first spring coupling the first side of the steering arm to a first actuation pushrod of the first brake master cylinder, the second spring coupling the second side of the steering arm to a second actuation pushrod of the second brake master cylinder;
a second steering system comprising a transmission that includes a right side drive shaft and a left side drive shaft, the right side drive shaft coupled to a right side disk brake that is in fluid communication with the first brake master cylinder, the left side drive shaft coupled to a left side disk brake that is in fluid communication with the second brake master cylinder,
wherein the first steering system provides a first turning rate when rotating the steering shaft by an amount of rotation in a first direction or a second direction by compressing the first spring to move the first actuation pushrod into the first brake master cylinder to increase a first brake fluid pressure to apply a braking force to the right disk brake, or by compressing the second spring to move the second actuation pushrod into the second brake master cylinder to increase the second brake fluid pressure to apply a braking force to the left side disk brake,
wherein the second steering system provides the second turning rate when the braking force is applied to the right side disc brake by causing the transmission to increase a rotational speed of the left side drive shaft of the transmission as a ratio of a reduction in rotational speed of the right side drive shaft, and
wherein the second steering system provides the second turning rate when the braking force is applied to the left side disc brake by causing the transmission to increase a rotational speed of the right side drive shaft of the transmission as a ratio of a reduction in rotational speed of the left side drive shaft.

23. The progressive brake steering system of claim 22, wherein the first steering system further comprises a first bullnose washer and a second bullnose washer, wherein the first bullnose washer is positioned on the first actuation pushrod between a first side of the steering arm and the first spring, the first actuation pushrod extending through an inner opening of the first bullnose washer and through an opening on the first side of the steering arm, wherein the second bullnose washer is positioned on the second actuation pushrod between a second side of the steering arm and the second spring, the second actuation pushrod extending through an inner opening of the second bullnose washer and through an opening on the second side of the steering arm.
